(19) United States
(12) Patent Application Publication
(10) Pub. No.: US 2026/0095827 A1
(43) Pub. Date: Apr. 2, 2026

(54) MEASURING FOR CELL RESELECTION BASED ON A CELL STATE

(71) Applicant: Lenovo (Singapore) Pte. Ltd., Singapore (SG)

(72) Inventors: Hyejung Jung, Northbrook, IL (US); Prateek Basu Mallick, Dreieich (DE); Joachim Löhr, Wiesbaden (DE); Vijay Nangia, Woodridge, IL (US)

(21) Appl. No.: 19/111,671

(22) PCT Filed: Sep. 26, 2023
(86) PCT No.: PCT/IB2023/059550

§ 371 Date: Mar. 13, 2025

Related U.S. Application Data
(60) Provisional application No. 63/377,192, filed on Sep. 26, 2022.

(51) Int. Cl. H04W 36/00; H04W 36/32

(52) U.S. Cl. CPC H04W 36/0085; H04W 36/322

(57) ABSTRACT

Apparatuses, methods, and systems are disclosed for measuring for cell reselection based on a cell state. One method (500) includes camping (502), at a user equipment, on a cell. The method (500) includes receiving (504) information indicating a change of a cell operating state of the cell. The method (500) includes performing (506) measurements for cell reselection based on the information indicating the change of the cell operating state of the cell. The measurements for cell reselection include intra-frequency measurements, inter-frequency measurements, inter-RAT measurements, or a combination thereof.

### FIELD

The subject matter disclosed herein relates generally to wireless communications and more particularly relates to measuring for cell reselection based on a cell state.

### BACKGROUND

In certain wireless communications systems, synchronization signals may be used. In such systems, there may be high energy consumption.

### BRIEF SUMMARY

Methods for measuring for cell reselection based on a cell state are disclosed. Apparatuses and systems also perform the functions of the methods. One embodiment of a method includes camping, at a user equipment (“UE”), on a cell. In some embodiments, the method includes receiving information indicating a change of a cell operating state of the cell. In certain embodiments, the method includes performing measurements for cell reselection based on the information indicating the change of the cell operating state of the cell. The measurements for cell reselection include intra-frequency measurements, inter-frequency measurements, inter-radio access technology (“RAT”) measurements, or a combination thereof.

One apparatus for measuring for cell reselection based on a cell state includes a processor. In some embodiments, the apparatus includes a memory coupled with the processor, the processor configured to cause the apparatus to: camp on a cell; receive information indicating a change of a cell operating state of the cell; and perform measurements for cell reselection based on the information indicating the change of the cell operating state of the cell, wherein the measurements for cell reselection include intra-frequency measurements, inter-frequency measurements, inter-RAT measurements, or a combination thereof.

Another embodiment of a method for measuring for cell reselection based on a cell state includes transmitting, at a network device, information indicating a change of a cell operating state of the cell. The information indicating the change of the cell operating state of the cell includes an indication for the cell to transition to a cell inactive state, and the cell transmits a discovery signal and channel only while in the cell inactive state.

Another apparatus for measuring for cell reselection based on a cell state includes a processor. In some embodiments, the apparatus includes a memory coupled with the processor, the processor configured to cause the apparatus to: transmit information indicating a change of a cell operating state of the cell. The information indicating the change of the cell operating state of the cell includes an indication for the cell to transition to a cell inactive state, and the cell transmits a discovery signal and channel only while in the cell inactive state.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for measuring for cell reselection based on a cell state;

FIG. 2 is a schematic block diagram illustrating one embodiment of an apparatus that may be used for measuring for cell reselection based on a cell state;

FIG. 3 is a schematic block diagram illustrating one embodiment of an apparatus that may be used for measuring for cell reselection based on a cell state;

FIG. 4 is a schematic block diagram illustrating one embodiment of code for a master information block (“MIB”);

FIG. 5 is a flow chart diagram illustrating one embodiment of a method for measuring for cell reselection based on a cell state; and

FIG. 6 is a flow chart diagram illustrating another embodiment of a method for measuring for cell reselection based on a cell state.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

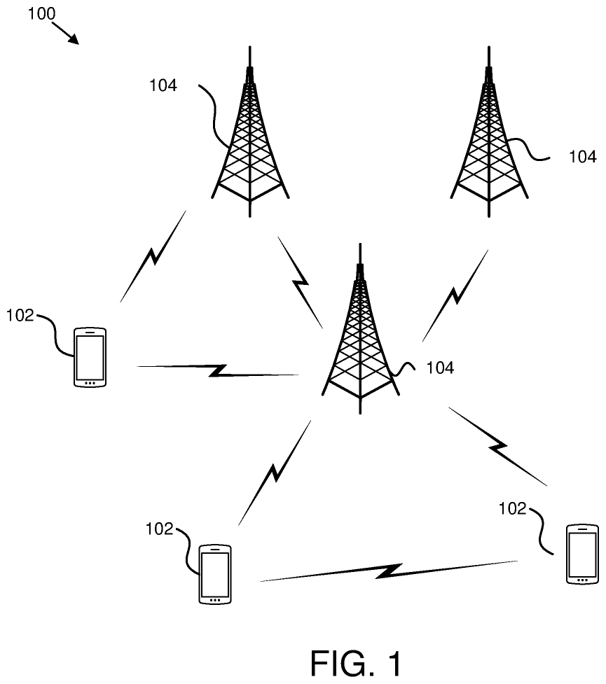

FIG. 1 depicts an embodiment of a wireless communication system 100 for measuring for cell reselection based on a cell state. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may camp on a cell. In some embodiments, the remote unit 102 may receive information indicating a change of a cell operating state of the cell. In certain embodiments, the remote unit 102 may perform measurements for cell reselection based on the information indicating the change of the cell operating state of the cell. The measurements for cell reselection include intra-frequency measurements, inter-frequency measurements, inter-RAT measurements, or a combination thereof. Accordingly, the remote unit 102 may be used for measuring for cell reselection based on a cell state.

In certain embodiments, a network unit 104 may transmit information indicating a change of a cell operating state of the cell. The information indicating the change of the cell operating state of the cell includes an indication for the cell to transition to a cell inactive state, and the cell transmits a discovery signal and channel only while in the cell inactive state. Accordingly, the network unit 104 may be used for measuring for cell reselection based on a cell state.

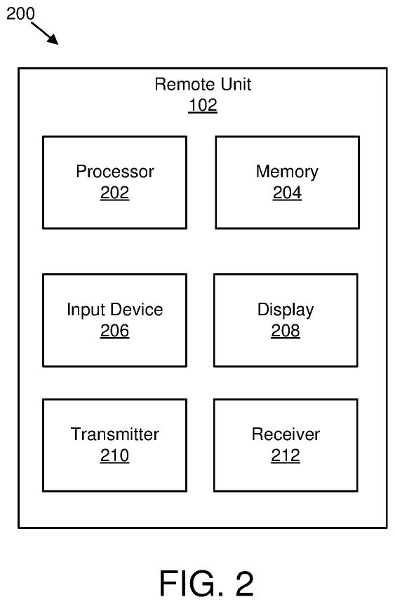

FIG. 2 depicts one embodiment of an apparatus 200 that may be used for measuring for cell reselection based on a cell state. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the remote unit 102 to: camp on a cell; receive information indicating a change of a cell operating state of the cell; and perform measurements for cell reselection based on the information indicating the change of the cell operating state of the cell. The measurements for cell reselection include intra-frequency measurements, inter-frequency measurements, inter-RAT measurements, or a combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

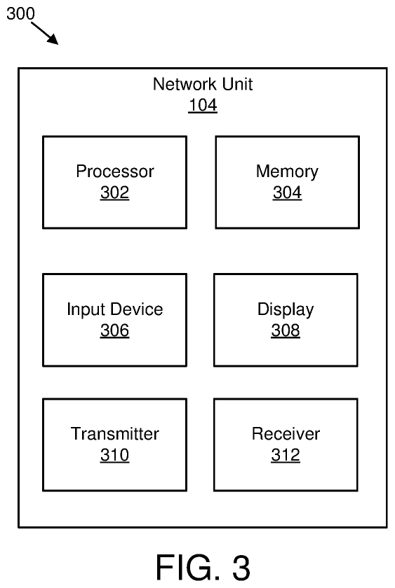

FIG. 3 depicts one embodiment of an apparatus 300 that may be used for measuring for cell reselection based on a cell state. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the network unit 104 to: transmit information indicating a change of a cell operating state of the cell. The information indicating the change of the cell operating state of the cell includes an indication for the cell to transition to a cell inactive state, and the cell transmits a discovery signal and channel only while in the cell inactive state.

It should be noted that one or more embodiments described herein may be combined into a single embodiment.

In certain embodiments, such as in 3GPP new radio (“NR”), there may be a configurable synchronization signal (“SS”) and physical broadcast channel (“PBCH”) (“SS/PBCH” block (“SSB”)) having a periodicity ranging from 5 milliseconds to 160 milliseconds and on-demand system information (“SI”) delivery for energy efficient operation. However, in such embodiments, there may be densely deployed network nodes and relatively high energy consumption per node from massive multiple input multiple output (“MIMO”) and/or high frequency band operations that may benefit from further reduction of energy consumption.

Described herein are various embodiments related to using different network energy saving states or sleep modes for cell on and/or off operation, allowing discovery and measurement of a cell in a cell inactive state, and change of network energy saving states based on assistant information from a user equipment (“UE”).

In some embodiments, cell selection and reselection processes in NR may be provided in a variety of ways. Regarding cell selection criterion, the cell selection criterion S is fulfilled when:

$$Srxlev > 0 AND Squal > 0$$

where:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ

Squal=Q_{qualmeas}−(Q_{qualmin}+Q_{qualminoffset})−Qoffsetₜₑₘₚ
where:

| | |
|---|---|
| Srxlev | Cell selection RX level value (dB) |
| Squal | Cell selection quality value (dB) |
| Qoffsetₜₑₘₚ | Offset temporarily applied to a cell |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained |
| | from q-RxLevMinSUL, if present, in SIB1, SIB2 and SIB4, |
| | additionally, if Q_{rxlevminoffsetcellSUL} is present in SIB3 and |
| | SIB4 for the concerned cell, this cell specific offset is |
| | added to the corresponding Qrxlevmin to achieve the |
| | required minimum RX level in the concerned cell; |
| | else Qᵣₓₗₑᵥₘᵢₙ is obtained from q-RxLevMin in SIB1, SIB2 |
| | and SIB4, additionally, if Q_{rxlevminoffsetcell} is present in SIB3 |
| | and SIB4 for the concerned cell, this cell specific offset is |
| | added to the corresponding Qrxlevmin to achieve the |
| | required minimum RX level in the concerned cell. |
| Q_{qualmin} | Minimum required quality level in the cell (dB). |
| | Additionally, if Q_{qualminoffsetcell} is signalled for the |
| | concerned cell, this cell specific offset is added to achieve |
| | the required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority public land mobile network (“PLMN”) |
| | while camped normally in a visited public land mobile |
| | network (“VPLMN”). |
| Q_{qualminoffset} | Offset to the signalled Q_{qualmin} taken into account in the |
| | Squal evaluation as a result of a periodic search for a |
| | higher priority PLMN while camped normally in a |
| | VPLMN. |
| P_{compensation} | For FR1, if the UE supports the additionalPmax in the |
| | NR-NS-PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, | Maximum TX power level of a UE may use when |
| P_{EMAX2} | transmitting on the uplink in the cell (dBm) defined as |
| | P_{EMAX}. If UE supports SUL frequency for this cell, |
| | P_{EMAX1} and P_{EMAX2} are obtained from the p-Max for SUL |
| | in SIB1 and NR-NS-PmaxList for SUL respectively in |
| | SIB1, SIB2 and SIB4, else P_{EMAX1} and P_{EMAX2} are |
| | obtained from the p-Max and NR-NS-PmaxList |
| | respectively in SIB1, SIB2 and SIB4 for normal UL. |
| P_{PowerClass} | Maximum RF output power of the UE (dBm) according |
| | to the UE power class. |

In various embodiments, regarding reselection priorities handling, absolute priorities of different NR frequencies or inter-RAT frequencies may be provided to a UE in system information, in an RRCRelease message, or by inheriting information from another RAT at inter-RAT cell selection (or reselection). For system information, an NR frequency or inter-RAT frequency may be used and/or indicated without providing a priority (e.g., the field cellReselectionPriority is absent for that frequency). If any fields with cellReselectionPriority or nsag-CellReselectionPriority are provided in dedicated signaling, the UE may ignore any fields with cellReselectionPriority and nsag-CellReselectionPriority provided in system information.

In certain embodiments, if a UE is in a camped normally state, and if it supports slice-based cell reselection and has received network slice access stratum groups (“NSAGs”) and their priorities from non-access stratum (“NAS”), the UE may derive re-selection priorities according to the following rules: 1) frequencies that support at least one prioritized NSAG received from NAS have higher re-selection priority than frequencies that support none of the NSAGs received from NAS; 2) frequencies that support at least one NSAG provided by NAS are prioritized in the order of the NAS-provided priority for the NSAG with highest priority supported on the frequency; 3) among the frequencies (e.g., one or multiple) that support the highest prioritized NSAGs with the same NAS-provided priorities, the frequencies are prioritized in the order of their nsag-CellReselectionPriority given for these NSAGs; 4) frequencies that support a NSAG provided by NAS and that indicate nsag-CellReselectionPriority for the NSAG have higher re-selection priority than frequencies that support this prioritized NSAG without indicating nsag-CellReselectionPriority for the NSAG; and 5) frequencies that support none of the NSAGs provided by NAS are prioritized in the order of their cellReselectionPriority.

In some embodiments, if a UE is in camped on any cell state, the UE may only apply the priorities provided by system information from a current cell, and the UE preserves priorities provided by dedicated signaling and deprioritisationReq received in RRCRelease unless specified otherwise. When the UE in camped normally state has only dedicated priorities other than for the current frequency, the UE may consider the current frequency to be the lowest priority frequency (e.g., lower than any of the network configured values). When the high speed dedicated network (“HSDN”) capable UE is in high-mobility state, the UE may always consider the HSDN cells to be the highest priority (e.g., higher than any other network configured priorities). When the HSDN capable UE is not in a high-mobility state, the UE may always consider HSDN cells to be the lowest priority (e.g., lower than any other network configured priorities). If the UE is configured to perform both NR sidelink communication and vehicle to everything (“V2X”) sidelink communication, the UE may consider the frequency providing both NR sidelink communication configuration and V2X sidelink communication configuration to be the highest priority. If the UE is configured to perform NR sidelink communication and not perform V2X communication, the UE may consider the frequency providing NR sidelink communication configuration to be the highest priority. If the UE is configured to perform V2X sidelink communication and not perform NR sidelink communication, the UE may consider the frequency providing V2X sidelink communication configuration to be the highest priority.

In such embodiments, it should be noted that: 1) the frequency only providing the anchor frequency configuration should not be prioritized for V2X service during cell reselection; 2) when the UE is configured to perform NR sidelink communication or V2X sidelink communication performs cell reselection, it may consider the frequencies providing the intra-carrier and inter-carrier configuration have equal priority in cell reselection; 3) the prioritization among the frequencies which the UE considers to be the highest priority frequency is left to UE implementation; 4) the UE is configured to perform V2X sidelink communication or NR sidelink communication if it has the capability and is authorized for the corresponding sidelink operation; and 5) when the UE is configured to perform both NR sidelink communication and V2X sidelink communication but cannot find a frequency which can provide both NR sidelink communication configuration and V2X sidelink communication configuration, the UE may consider the frequency providing either NR sidelink communication configuration or V2X sidelink communication configuration to be the highest priority.

In various embodiments, a UE may only perform cell reselection evaluation for NR frequencies and inter-RAT frequencies that are given in system information and for which the UE has a priority provided.

If the UE receives RRCRelease with deprioritisationReq, the UE may consider a current frequency and stored frequencies due to previously received RRCRelease with deprioritisationReq or all the frequencies of NR to be the lowest priority frequency (e.g., lower than any of the network configured values) while T325 is running irrespective of a camped RAT. The UE may delete the stored deprioritization requests when a PLMN selection or stand-alone non-public network (“SNPN”) selection is performed on request by NAS. It should be noted that the UE may search for a higher priority layer for cell reselection as soon as possible after the change of priority.

In certain embodiments, a UE may delete priorities provided by dedicated signaling when: 1) the UE enters a different radio resource control (“RRC”) state; 2) the optional validity time of dedicated priorities (e.g., T320) expires; 3) the UE receives an RRCRelease message with the field cellReselectionPriorities absent; or 4) a PLMN selection or SNPN selection is performed on request by NAS. It should be noted that equal priorities between RATs are not supported.

In some embodiments, a UE may not consider any exclude-listed cells as candidate for cell reselection. The UE may consider only the allow-listed cells, if configured, as candidates for cell reselection. Moreover, the UE in an RRC_IDLE state may inherit the priorities provided by dedicated signaling and the remaining validity time (e.g., T320 in NR and evolved universal terrestrial radio access (“E-UTRA”)), if configured, at inter-RAT cell selection (or reselection). It should be noted that the network may assign dedicated cell reselection priorities for frequencies not configured by system information.

In various embodiments, regarding NR inter-frequency and inter-RAT cell reselection criteria, if threshServingLowQ is broadcast in system information and more than 1 second has elapsed since the UE camped on the current serving cell, cell reselection to a cell on a higher priority NR frequency or inter-RAT frequency than the serving frequency may be performed if a cell of a higher priority NR or E-UTRAN RAT and/or frequency fulfils Squal>ThreshX, HighQ during a time interval TreselectionRAT; otherwise, a cell reselection to a cell on a higher priority NR frequency or inter-RAT frequency than the serving frequency may be performed if: 1) a cell of a higher priority RAT and/or frequency fulfils Srxlev>ThreshX, HighP during a time interval TreselectionRAT; and 2) more than 1 second has elapsed since the UE camped on the current serving cell.

In certain embodiments, cell reselection to a cell on an equal priority NR frequency may be based on ranking for intra-frequency cell reselection. If threshServingLowQ is broadcast in system information and more than 1 second has elapsed since the UE camped on the current serving cell, cell reselection to a cell on a lower priority NR frequency or inter-RAT frequency than the serving frequency may be performed if: the serving cell fulfils Squal<ThreshServing, LowQ and a cell of a lower priority NR or E-UTRA network (“E-UTRAN”) RAT and/or frequency fulfils Squal>ThreshX, LowQ during a time interval TreselectionRAT; otherwise, cell reselection to a cell on a lower priority NR frequency or inter-RAT frequency than the serving frequency may be performed if: 1) the serving cell fulfils Srxlev<ThreshServing, LowP and a cell of a lower priority RAT and/or frequency fulfils Srxlev>ThreshX, LowP during a time interval TreselectionRAT; and 2) more than 1 second has elapsed since the UE camped on the current serving cell.

In some embodiments, for a UE performing slice-based cell reselection if a best cell in a frequency fulfils the above criteria for cell reselection based on re-selection priority for the frequency and NSAG, but this cell does not support the NSAG, the UE may re-derive a re-selection priority for the frequency by considering the NSAGs supported by this cell (e.g., rather than those of the corresponding NR frequency). This reselection priority is used for a maximum of 300 seconds, or until new information of NSAGs and their priorities are received from NAS. The UE may ensure the cell reselection criteria above are fulfilled based on the newly derived priorities.

In various embodiments, cell reselection to a higher priority RAT and/or frequency may take precedence over a lower priority RAT and/or frequency if multiple cells of different priorities fulfil the cell reselection criteria. If more than one cell meets the above criteria, the UE may reselect a cell as follows: 1) if a highest-priority frequency is an NR frequency, the highest ranked cell among the cells on the highest priority frequencies meeting the criteria; and 2) if the highest-priority frequency is from another RAT, the strongest cell among the cells on the highest priority frequencies meeting the criteria of that RAT.

In certain embodiments, regarding intra-frequency and equal priority inter-frequency cell reselection criteria, the cell-ranking criterion Rs for a serving cell and Rn for neighboring cells is defined by:

$${R}_{s} = {Q}_{meas , s} + {Q}_{hyst} - {Qoffset}_{temp}$$

$${R}_{n} = {Q}_{meas , n} - Qoffset - {Qoffset}_{temp}$$

where:

| | |
|---|---|
| Qₘₑₐₛ | RSRP measurement quantity used in cell |
| | reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell |

In some embodiments, a UE may perform ranking of all cells that fulfil cell selection criterion S. The cells may be ranked according to the R criteria by deriving Q_{meas,n} and Q_{meas,s} and calculating the R values using averaged RSRP results. If rangeToBestCell is not configured, the UE may perform cell reselection to the highest ranked cell which is found to be suitable. If rangeToBestCell is configured, then the UE may perform cell reselection to the cell with the highest number of beams above the threshold (e.g., absThreshSS-BlocksConsolidation) among the cells whose R value is within rangeToBestCell of the R value of the highest ranked cell. If there are multiple such cells, the UE may perform cell reselection to the highest ranked cell among them, which is found to be suitable. In all cases, the UE may reselect the new cell, only if the following conditions are met: 1) the new cell is better than the serving cell according to the cell reselection criteria specified during a time interval TreselectionRAT; and 2) more than 1 second has elapsed since the UE camped on the current serving cell. It should be noted that, if rangeToBestCell is configured but absThreshSS-BlocksConsolidation is not configured on an NR frequency, the UE considers that there is one beam above the threshold for each cell on that frequency.

In one embodiment, a network entity may flexibly change (e.g., dynamically change via DCI or medium access control (“MAC”) control element (“CE”)) a set of actually transmitted synchronization signal (“SS”) and/or physical broadcast channel (“PBCH”) blocks (“SSBs”) out of a set of predefined SSB candidate positions based on a UEs' spatial distribution (e.g., for RRC connected mode UEs) and predicted (or estimated) UE locations (e.g., knowledge of UE spatial distribution (e.g., office parks, residential area, etc.) for different times of a day). For example, the network entity may estimate current UE locations and/or orientations using 3GPP and/or non-3GPP positioning technologies, 3GPP channel state information (“CSI”) reporting (e.g., layer 1 (“L1”) reference signal received power (“RSRP”) (“L1-RSRP”), L1 signal-to-interference and noise ratio (“SINR”) (“L1-SINR”) reporting) and/or mobility measurement reporting, various sensors (e.g., radar and camera). Moreover, the network may predict future UE locations based on estimated UEs' movement directions and speeds (e.g., additionally using artificial intelligence and/or machine learning), and adjust a SSB transmission pattern within a half frame accordingly.

In another embodiment, a network entity may transmit a plurality of SSBs within a half frame with different periodicities. In one example, in response to a network entity determining that there are no or few RRC connected UEs served by a set of SSBs (e.g., DL transmit (“TX”) beams, based on UEs' CSI reporting and/or there are very few UEs in locations related to the set of SSBs in a cell), the network entity may configure a longer periodicity (e.g., 20 ms or longer) for the set of SSBs. In another example, a plurality of SSBs within a half frame may be grouped in a plurality of SSBs sets with different and/or independent periodicities configuration for different SSBs sets (e.g., longer periodicity for SSBs in a SSB set with very few UEs in locations related to the (e.g., or within coverage of) the SSBs in the SSB set). In a further example, when a network entity provides one or more tracking reference signal (“TRS”) occasions which are configured for RRC connected UEs and associated (e.g., quasi-co-located) with a set of SSBs, to RRC idle and/or inactive UEs in a cell, the network entity may configure a longer periodicity for the set of SSBs.

In certain embodiments, a cell may be configured with a long SSB periodicity (e.g., longer than 160 ms) for network energy saving.

In some embodiments, there may be network energy saving states.

In various embodiments, a network entity indicates for a cell to go to a cell sleep state or a cell inactive state, where the cell in the cell sleep state neither transmits nor receives, and where the cell in the cell inactive sate (or cell energy saving state) transmits a cell discovery signal and/or channel and/or receives an uplink signal and/or channel carrying assistance information from a UE. The network entity may also indicate a time interval for which the cell sleep state or the cell inactive state applies to the cell. The network entity may transmit a configuration for a cell discovery signal and/or channel and a configuration for an uplink signal and/or channel carrying assistance information from a UE. The cell discovery signal and/or channel may include a burst of SSBs and may further include a burst of corresponding physical downlink control channels (“PDCCHs”) and/or physical downlink shared channels (“PDSCHs”) for system information block type1 (“SIB1”) or for compact system information (e.g., system information block type0 (“SIB0”)). For example, SIB0 includes configuration for a discovery signal and/or channel, cell selection related parameters, cell access related information, configuration for transmission of UE assistance information, but does not include a full serving cell configuration and system information (“SI”) scheduling information. In another example, the uplink signal and/or channel carrying the assistance information from the UE includes resources for small data transmission (“SDT”) and/or random access resources (e.g., 2-step random access channel (“RACH”) and/or 4-step RACH).

In certain embodiments, an indication of going to a cell sleep state or a cell inactive state is sent via broadcast system information, via a broadcast master information block, or via dedicated RRC signaling. In some embodiments, an indication of going to a cell sleep state or a cell inactive state is sent via downlink control information (“DCI”) (e.g., group-common DCI or SSB-set common DCI associated with UE locations within a coverage area of the set of SSBs corresponding to which the cell operating state is being transitioned to a cell sleep state or cell inactive state).

In various embodiments, upon receiving an indication of a cell inactive mode, a UE in an RRC_CONNECTED state considers semi-statically configured or semi-persistently scheduled DL resources such as semi-persistent scheduling (“SPS”) PDSCH, PDCCH monitoring occasions, periodic, or semi-persistent CSI reference signal (“RS”) (“CSI-RS”) occasions are deactivated for an indicated time interval.

In certain embodiments, if a UE is configured with a periodic discovery signal window that includes synchronization signals and a PDCCH monitoring occasions for a cell inactive state, the UE performs re-synchronization and PDCCH monitoring within the periodic discovery signal window.

In some embodiments, there may be cell selection and/or reselection with network energy saving states.

In one embodiment, upon receiving an indication of a cell sleep state (e.g., a parameter cellSleepState in Example 1) for a cell, a UE camping on the cell in an RRC_IDLE (or RRC_INACTIVE) state initiates intra-frequency, inter-frequency, or inter-RAT measurements regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ, as shown in Example 1, performs cell reselection evaluation, and camps on a reselected cell. The UE considers the cell being barred and does not camp on the cell. If the UE receives an indication of time interval for the cell being in the cell sleep state, the UE considers the cell being barred for the indicated time interval and does not camp on the cell for the indicated time interval. In one implementation, the UE considers the cell entering into a cell inactive state at the end of the indicated time interval of the cell sleep state.

In another embodiment, upon receiving an indication of a cell inactive state (e.g. a parameter celllactiveState in Example 1) for a cell, a UE camping on the cell in an RRC_IDLE (or RRC_INACTIVE) state starts to use a cell discovery signal and/or channel for measurements of the cell. In one implementation, if the UE receives an indication of time interval for the cell being in the cell inactive state, the UE considers the cell entering into a cell active state at the end of the indicated time interval of the cell inactive state.

In certain embodiments, if an uplink signal and/or channel carrying assistance information from the UE (e.g., a parameter ueRequestForCellActive in Example 1) is configured, the UE follows a legacy serving cell measurement procedure (e.g., the UE may not perform intra-frequency measurements if serving cell measurement results such as Srxlev and Squal are above configured threshold values). When the UE continues camping on the cell and expects some uplink and/or downlink data arrival based on an active applications, the UE may send a request for a cell active state using the uplink signal and/or channel configured for assistance information from the UE. In one implementation, the UE may consider the cell to be the lowest priority for cell reselection.

In some embodiments, if an uplink signal and/or channel carrying assistance information from the UE (e.g., a parameter ueRequestForCellActive in Example 1) is not configured, the UE initiates intra-frequency, inter-frequency, or inter-RAT measurements regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ, as shown in Example 1, performs cell reselection evaluation, and camps on a reselected cell. In one implementation, while the UE does not consider the cell being barred (e.g., may continue camping on the cell), the UE considers the cell to be the lowest priority (e.g., lower than any other network configured priorities) for cell reselection.

In various embodiments, if an uplink signal and/or channel carrying assistance information from a UE is configured in a cell of a cell inactive state, the UE may send a cell operating state transition request for a cell active state as needed and, accordingly, the UE may not have to perform cell reselection, unless cell reselection criteria are met. If an uplink signal and/or channel carrying assistance information from a UE is not configured, the UE may perform cell reselection with prioritizing other cells of the cell active state over the cell of the cell inactive state to avoid long access latency and potential performance degradation.

In Example 1 there may be measurement rules for cell re-selection. The listed rules are used by a UE to limit needed measurements.

### Example 1

```
If the serving cell fulfils Srxlev > SIntraSearchP and Squal > SIntraSearchQ:
  If distanceThresh is broadcasted in SIB19, and if UE supports location-based
  measurement initiation and has obtained its location information:
    If the distance between UE and the serving cell reference location is shorter
    than distanceThresh, the UE may not perform intra-frequency measurements;
    Otherwise, the UE shall perform intra-frequency measurements;
  Elseif cellIactiveState is broadcasted in SIBx:
    if ueRequestForCellActive is configured, the UE may not perform intra-
    frequency measurements;
    Otherwise, the UE shall perform intra-frequency measurements;
  Elseif cellSleepState is broadcasted in SIBx:
    the UE shall perform intra-frequency measurement
  Otherwise, the UE may not perform intra-frequency measurements;
Otherwise, the UE shall perform intra-frequency measurements.
The UE shall apply the following rules for NR inter-frequencies and inter-RAT frequencies
which are indicated in system information and for which the UE has priority provided:
  For a NR inter-frequency or inter-RAT frequency with a reselection priority higher
  than the reselection priority of the current NR frequency, the UE shall perform
  measurements of higher priority NR inter-frequency or inter-RAT frequencies.
  For a NR inter-frequency with an equal or lower reselection priority than the
  reselection priority of the current NR frequency and for inter-RAT frequency with
  lower reselection priority than the reselection priority of the current NR frequency:
    If the serving cell fulfils Srxlev > SnonIntraSearchP and Squal >
    SnonIntraSearchQ:
      If distanceThresh is broadcasted in SIB19, and if UE supports location-
      based measurement initiation and has valid UE location information:
        If the distance between UE and the serving cell reference
        location is shorter than distanceThresh, the UE may choose not
        to perform measurements of NR inter-frequency cells of equal or
        lower priority, or inter-RAT frequency cells of lower priority;
        Otherwise, the UE shall perform measurements of NR inter-
        frequency cells of equal or lower priority, or inter-RAT
        frequency cells of lower priority;
      Elseif cellIactiveState is broadcasted in SIBx:
        if ueRequestForCellActive is configured, the UE may choose not
        to perform measurements of NR inter-frequency cells of equal or
        lower priority, or inter-RAT frequency cells of lower priority;
        Otherwise, the UE shall perform measurements of NR inter-
        frequency cells of equal or lower priority, or inter-RAT
        frequency cells of lower priority;
      Elseif cellSleepState is broadcasted in SIBx:
        the UE shall perform measurements of NR inter-frequency cells
        of equal or lower priority, or inter-RAT frequency cells of lower
        priority
      Otherwise, the UE may choose not to perform measurements of NR
      inter-frequency cells of equal or lower priority, or inter-RAT frequency
      cells of lower priority;
    Otherwise, the UE shall perform measurements of NR inter-frequency cells of
    equal or lower priority, or inter-RAT frequency cells of lower priority.
  If the UE supports relaxed measurement and relaxedMeasurement is present in SIB2,
  the UE may further relax the needed measurements.
```

In certain embodiments, for cell selection, if a UE receives an indication that the strongest cell in a given frequency layer is in a cell inactive state, the UE may search for the next strongest cell.

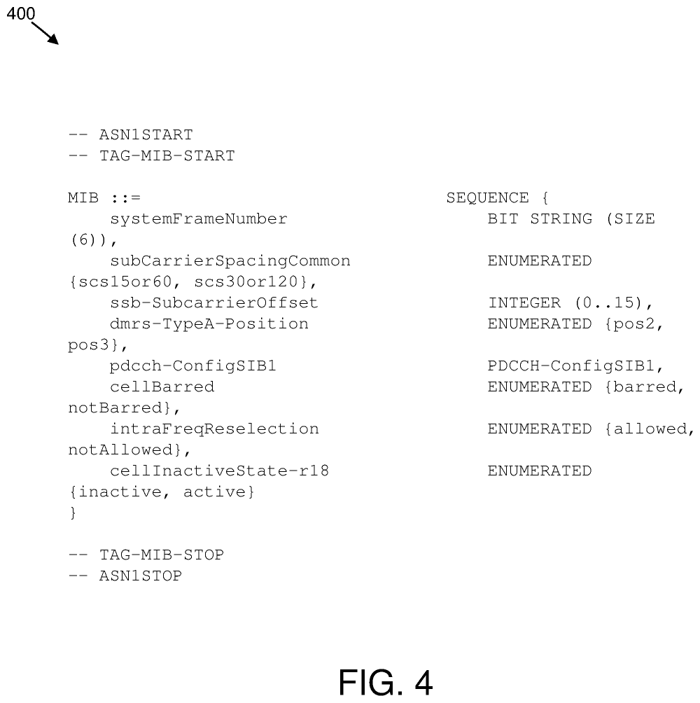

In some embodiments, one reserved bit in a master information block (“MIB”) of NR is repurposed as the bitfield cellInactive State to indicate whether a corresponding cell is in a cell inactive state or not, as shown in FIG. 4. When a cell is in a cell inactive state, the cell may indicate via the field cellBarred that the cell is barred, to avoid legacy UEs (e.g., UEs that cannot recognize the field cellInactiveState) camping on the cell. For a UE recognizing the field cellInactiveState, the indication of the cell barred is ignored, when the field cellInactiveState indicates the cell inactive state.

FIG. 4 is a schematic block diagram illustrating one embodiment of code 400 for a MIB. In FIG. 4, the field “cellBarred” may include a value indicating barred (e.g., that the cell is barred). This field may be ignored by an IAB-MT. Moreover, this field may be ignored for connectivity to a non-terrestrial network (“NTN”). Further, the field “cellInactiveState” may indicate a value inactive that means that the cell is in a cell inactive state (e.g., discovery signal and/or channel transmission with limited system information). If this field is set to inactive, the bitfield cellBarred is ignored.

In various embodiments, a UE receives information of a list of neighboring cells being in a cell inactive state via system information or a dedicated RRC message such as RRCRelease. For cell reselection, the UE considers the list of neighboring cells in the cell inactive state as the lowest priority.

In certain embodiments, a UE may request for change of a network energy saving state. In one embodiment, a UE sends to a network entity a request for change from a cell inactive state to a cell active state (e.g., via transmission of a preamble and/or an RRC message (e.g., CellActiveRequest)). In one example, an RRC message CellActiveRequest includes UE assistance information such as expected quality of service (“QoS”) and/or a network slice. In response to the request, the UE may receive an indication via a common PDCCH or broadcast system information (e.g., SIB0) that the cell is transitioning to the cell active state. In some embodiments, in response to a request, a UE may receive an indication that rejects the UE request for change to the cell inactive state (e.g., via a PDCCH or a RRC message). The RRC message rejecting the request may further indicate a list of neighboring cells being in a cell inactive state (or a list of neighboring cells being in a cell active state). The UE performs cell reselection upon receiving the indication that rejects the UE request.

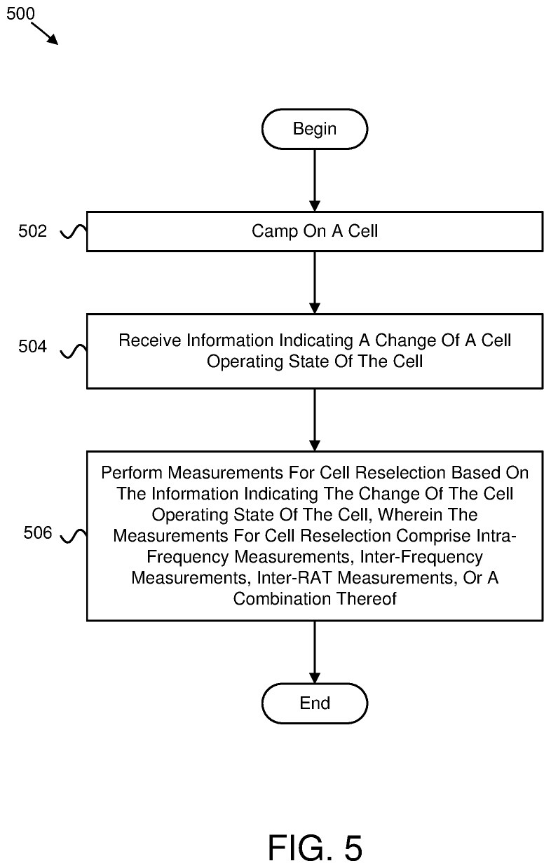

FIG. 5 is a flow chart diagram illustrating one embodiment of a method 500 for measuring for cell reselection based on a cell state. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes camping 502 on a cell. In some embodiments, the method 500 includes receiving 504 information indicating a change of a cell operating state of the cell. In certain embodiments, the method 500 includes performing 506 measurements for cell reselection based on the information indicating the change of the cell operating state of the cell. The measurements for cell reselection include intra-frequency measurements, inter-frequency measurements, inter-RAT measurements, or a combination thereof.

In certain embodiments, the information indicating the change of the cell operating state of the cell comprises an indication for the cell to transition to a cell sleep state, the cell neither transmits nor receives while being in the cell sleep state, and the measurements for cell reselection are performed regardless of: a distance between the UE and a serving cell reference location; whether a cell selection receiver level value is larger than configured receiver level threshold values; whether a cell selection quality value is larger than configured quality threshold values; or a combination thereof. In some embodiments, the method 500 further comprises performing cell reselection based on the measurements, wherein the UE considers the cell as barred for the cell reselection. In various embodiments, the information indicating the change of the cell operating state of the cell comprises an indication for the cell to transition to a cell inactive state, and the cell transmits a discovery signal and channel only while in the cell inactive state.

In one embodiment: in response to an uplink resource for assistance information from the UE being configured, the measurements for cell reselection are performed: in response to a distance between the UE and a serving cell reference location being not less than a configured distance threshold value; in response to a cell selection receiver level value being not larger than configured receiver level threshold values; in response to a cell selection quality value being not larger than configured quality threshold values; or a combination thereof; and in response to the uplink resource for assistance information from the UE not being configured, the measurements for cell reselection are performed regardless of: the distance between the UE and the serving cell reference location; whether the cell selection receiver level value is larger than the configured receiver level threshold values; whether the cell selection quality value is larger than the configured quality threshold values; or a combination thereof. In certain embodiments, the method 500 further comprises performing cell reselection based on the measurements, wherein the UE considers the cell as the lowest priority for cell reselection. In some embodiments, the discovery signal and channel comprise a burst of synchronization signals and physical broadcast channel blocks and a burst of physical downlink channels carrying compact system information.

In various embodiments, the compact system information: comprises a configuration of the discovery signal and channel, cell selection related parameters, cell access related information, a configuration for transmission of UE assistance information, or a combination thereof, and does not include a serving cell configuration and SI scheduling information. In one embodiment, the indication for the cell to transition to the cell inactive state is included in a master information block, and a bitfield in the master information block indicating whether the cell is barred is ignored in response to the indication for the cell to transition to the cell inactive state.

In certain embodiments, the method 500 further comprises sending a request message to request that the cell changes from being in an energy saving state to being in a cell active state, wherein the request message comprises an expected QoS, a network slice, or a combination thereof. In some embodiments, the method 500 further comprises receiving a response message in response to sending the request message, wherein the response message rejects the request that the cell changes from being in the energy saving state to being in the cell active state, and the response message further comprises information of at least one neighbor cell being in the cell active state.

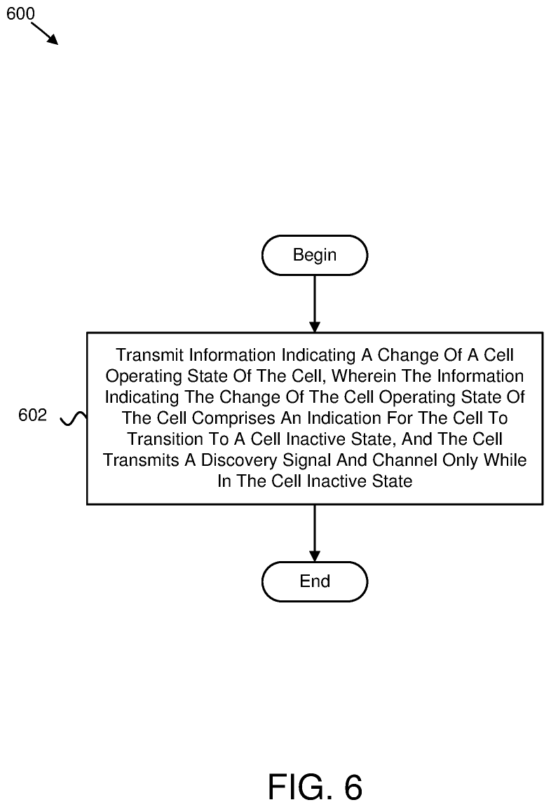

FIG. 6 is a flow chart diagram illustrating another embodiment of a method 600 for measuring for cell reselection based on a cell state. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602 information indicating a change of a cell operating state of the cell. The information indicating the change of the cell operating state of the cell includes an indication for the cell to transition to a cell inactive state, and the cell transmits a discovery signal and channel only while in the cell inactive state.

In certain embodiments, the discovery signal and channel comprise a burst of synchronization signals and physical broadcast channel blocks and a burst of physical downlink channels carrying compact system information. In some embodiments, the compact system information: comprises a configuration of the discovery signal and channel, cell selection related parameters, cell access related information, a configuration for transmission of UE assistance information, or a combination thereof, and does not include a serving cell configuration and SI scheduling information. In various embodiments, the indication for the cell to transition to the cell inactive state is included in a master information block.

In one embodiment, the method 600 further comprising receiving a request message to request that the cell changes from being in an energy saving state to being in a cell active state, wherein the request message comprises an expected QoS, a network slice, or a combination thereof. In certain embodiments, the method 600 further comprising transmitting a response message in response to receiving the request message, wherein the response message rejects the request that the cell changes from being in the energy saving state to being in the cell active state, and the response message further comprises information of at least one neighbor cell being in the cell active state.

In one embodiment, an apparatus for wireless communication, the apparatus comprises: a processor; and a memory coupled with the processor, the processor configured to cause the apparatus to: camp on a cell; receive information indicating a change of a cell operating state of the cell; and perform measurements for cell reselection based on the information indicating the change of the cell operating state of the cell, wherein the measurements for cell reselection comprise intra-frequency measurements, inter-frequency measurements, inter-RAT measurements, or a combination thereof.

In certain embodiments, the information indicating the change of the cell operating state of the cell comprises an indication for the cell to transition to a cell sleep state, the cell neither transmits nor receives while being in the cell sleep state, and the measurements for cell reselection are performed regardless of: a distance between the UE and a serving cell reference location; whether a cell selection receiver level value is larger than configured receiver level threshold values; whether a cell selection quality value is larger than configured quality threshold values; or a combination thereof.

In some embodiments, the processor further configured to cause the apparatus to perform cell reselection based on the measurements, and the UE considers the cell as barred for the cell reselection.

In various embodiments, the information indicating the change of the cell operating state of the cell comprises an indication for the cell to transition to a cell inactive state, and the cell transmits a discovery signal and channel only while in the cell inactive state.

In one embodiment, the processor further configured to cause the apparatus to: in response to an uplink resource for assistance information from the UE being configured, perform the measurements for cell reselection: in response to a distance between the UE and a serving cell reference location being not less than a configured distance threshold value; in response to a cell selection receiver level value being not larger than configured receiver level threshold values; in response to a cell selection quality value being not larger than configured quality threshold values; or a combination thereof, and in response to the uplink resource for assistance information from the UE not being configured, perform the measurements for cell reselection regardless of: the distance between the UE and the serving cell reference location; whether the cell selection receiver level value is larger than the configured receiver level threshold values; whether the cell selection quality value is larger than the configured quality threshold values; or a combination thereof.

In certain embodiments, the processor further configured to cause the apparatus to perform cell reselection based on the measurements, and the UE considers the cell as the lowest priority for cell reselection.

In some embodiments, the discovery signal and channel comprise a burst of synchronization signals and physical broadcast channel blocks and a burst of physical downlink channels carrying compact system information.

In various embodiments, the compact system information: comprises a configuration of the discovery signal and channel, cell selection related parameters, cell access related information, a configuration for transmission of UE assistance information, or a combination thereof, and does not include a serving cell configuration and SI scheduling information.

In one embodiment, the indication for the cell to transition to the cell inactive state is included in a master information block, and a bitfield in the master information block indicating whether the cell is barred is ignored in response to the indication for the cell to transition to the cell inactive state.

In certain embodiments, the processor further configured to cause the apparatus to send a request message to request that the cell changes from being in an energy saving state to being in a cell active state, and the request message comprises an expected QoS, a network slice, or a combination thereof.

In some embodiments, the processor further configured to cause the apparatus to receive a response message in response to sending the request message, the response message rejects the request that the cell changes from being in the energy saving state to being in the cell active state, and the response message further comprises information of at least one neighbor cell being in the cell active state.

In one embodiment, a method at a UE, the method comprises: camping on a cell; receiving information indicating a change of a cell operating state of the cell; and performing measurements for cell reselection based on the information indicating the change of the cell operating state of the cell, wherein the measurements for cell reselection comprise intra-frequency measurements, inter-frequency measurements, inter-RAT measurements, or a combination thereof.

In certain embodiments, the information indicating the change of the cell operating state of the cell comprises an indication for the cell to transition to a cell sleep state, the cell neither transmits nor receives while being in the cell sleep state, and the measurements for cell reselection are performed regardless of: a distance between the UE and a serving cell reference location; whether a cell selection receiver level value is larger than configured receiver level threshold values; whether a cell selection quality value is larger than configured quality threshold values; or a combination thereof.

In some embodiments, the method further comprises performing cell reselection based on the measurements, wherein the UE considers the cell as barred for the cell reselection.

In various embodiments, the information indicating the change of the cell operating state of the cell comprises an indication for the cell to transition to a cell inactive state, and the cell transmits a discovery signal and channel only while in the cell inactive state.

In one embodiment: in response to an uplink resource for assistance information from the UE being configured, the measurements for cell reselection are performed: in response to a distance between the UE and a serving cell reference location being not less than a configured distance threshold value; in response to a cell selection receiver level value being not larger than configured receiver level threshold values; in response to a cell selection quality value being not larger than configured quality threshold values; or a combination thereof; and in response to the uplink resource for assistance information from the UE not being configured, the measurements for cell reselection are performed regardless of: the distance between the UE and the serving cell reference location; whether the cell selection receiver level value is larger than the configured receiver level threshold values; whether the cell selection quality value is larger than the configured quality threshold values; or a combination thereof.

In certain embodiments, the method further comprises performing cell reselection based on the measurements, wherein the UE considers the cell as the lowest priority for cell reselection.

In some embodiments, the discovery signal and channel comprise a burst of synchronization signals and physical broadcast channel blocks and a burst of physical downlink channels carrying compact system information.

In various embodiments, the compact system information: comprises a configuration of the discovery signal and channel, cell selection related parameters, cell access related information, a configuration for transmission of UE assistance information, or a combination thereof, and does not include a serving cell configuration and SI scheduling information.

In one embodiment, the indication for the cell to transition to the cell inactive state is included in a master information block, and a bitfield in the master information block indicating whether the cell is barred is ignored in response to the indication for the cell to transition to the cell inactive state.

In certain embodiments, the method further comprises sending a request message to request that the cell changes from being in an energy saving state to being in a cell active state, wherein the request message comprises an expected QoS, a network slice, or a combination thereof.

In some embodiments, the method further comprises receiving a response message in response to sending the request message, wherein the response message rejects the request that the cell changes from being in the energy saving state to being in the cell active state, and the response message further comprises information of at least one neighbor cell being in the cell active state.

In one embodiment, an apparatus for wireless communication, the apparatus comprises: a processor; and a memory coupled with the processor, the processor configured to cause the apparatus to: transmit information indicating a change of a cell operating state of the cell, wherein the information indicating the change of the cell operating state of the cell comprises an indication for the cell to transition to a cell inactive state, and the cell transmits a discovery signal and channel only while in the cell inactive state.

In certain embodiments, the discovery signal and channel comprise a burst of synchronization signals and physical broadcast channel blocks and a burst of physical downlink channels carrying compact system information.

In some embodiments, the compact system information: comprises a configuration of the discovery signal and channel, cell selection related parameters, cell access related information, a configuration for transmission of UE assistance information, or a combination thereof; and does not include a serving cell configuration and SI scheduling information.

In various embodiments, the indication for the cell to transition to the cell inactive state is included in a master information block.

In one embodiment, the processor further configured to cause the apparatus to receive a request message to request that the cell changes from being in an energy saving state to being in a cell active state, and the request message comprises an expected QoS, a network slice, or a combination thereof.

In certain embodiments, the processor further configured to cause the apparatus to transmit a response message in response to receiving the request message, the response message rejects the request that the cell changes from being in the energy saving state to being in the cell active state, and the response message further comprises information of at least one neighbor cell being in the cell active state.

In one embodiment, a method at a network device, the method comprises: transmitting information indicating a change of a cell operating state of the cell, wherein the information indicating the change of the cell operating state of the cell comprises an indication for the cell to transition to a cell inactive state, and the cell transmits a discovery signal and channel only while in the cell inactive state.

In certain embodiments, the discovery signal and channel comprise a burst of synchronization signals and physical broadcast channel blocks and a burst of physical downlink channels carrying compact system information.

In some embodiments, the compact system information: comprises a configuration of the discovery signal and channel, cell selection related parameters, cell access related information, a configuration for transmission of UE assistance information, or a combination thereof; and does not include a serving cell configuration and SI scheduling information.

In various embodiments, the indication for the cell to transition to the cell inactive state is included in a master information block.

In one embodiment, the method further comprising receiving a request message to request that the cell changes from being in an energy saving state to being in a cell active state, wherein the request message comprises an expected QoS, a network slice, or a combination thereof.

In certain embodiments, the method further comprising transmitting a response message in response to receiving the request message, wherein the response message rejects the request that the cell changes from being in the energy saving state to being in the cell active state, and the response message further comprises information of at least one neighbor cell being in the cell active state.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Please make the following amendments to the claims:

1. A user equipment (UE), comprising:
at least one memory; and
at least one processor coupled with the at least one memory and configured to cause the UE to:
camp on a cell;
receive information indicating a change of a state of the cell; and
perform measurements for cell reselection based on the information indicating the change of the state of the cell, wherein the measurements for cell reselection comprise intra-frequency measurements, inter-frequency measurements, or inter-radio access technology (RAT) measurements, or a combination thereof.

2. The UE of claim 1, wherein state of the cell comprises a sleep state, wherein the sleep state indicates that no signals are transmitted or received during the sleep state, and wherein the measurements for cell reselection are performed regardless of:
a distance between the UE and a reference location of the cell;
whether a cell selection receiver level value is larger than a configured receiver level threshold values; or
whether a cell selection quality value is larger than a configured quality threshold values;
or a combination thereof.

3. The UE of claim 2, wherein the at least one processor is configured to cause the UE to:
perform cell reselection based on the performed measurements; and determine that the cell is barred for the cell reselection.

4. The UE of claim 1, wherein the state of the cell comprises an indication for the cell comprises an inactive state, and wherein the inactive state indicates that only discovery signals and channels are transmitted during the inactive state.

5. The UE of claim 4, wherein the at least one processor is configured to cause the UE to:
in response to an uplink resource for assistance information from the UE being configured, perform the measurements for cell reselection:
in response to a distance between the UE and a reference location of the cell being not less than a configured distance threshold value;
in response to a cell selection receiver level value being not larger than a configured receiver level threshold values; or
in response to a cell selection quality value being not larger than a configured quality threshold values;
or a combination thereof, and
in response to the uplink resource for assistance information from the UE not being configured, perform the measurements for cell reselection regardless of:
the distance between the UE and the reference location of the cell;
whether the cell selection receiver level value is larger than the configured receiver level threshold values; or
whether the cell selection quality value is larger than the configured quality threshold values;
or a combination thereof.

6. The UE of claim 4, wherein the at least one processor is configured to cause the UE to:
perform cell reselection based on the measurements; and
determine that the cell is the lowest priority for cell reselection.

7. The UE of claim 4, wherein the discovery signal and channel comprise a burst of synchronization signals and physical broadcast channel (PBCH) blocks and a burst of physical downlink channels carrying compact system information.

8. The UE of claim 7, wherein the compact system information:
comprises a configuration of the discovery signal and channel, cell selection related parameters, cell access related information, or a configuration for transmission of UE assistance information, or a combination thereof; and
does not include a serving cell configuration and system information (SI) scheduling information.

9. The UE of claim 4, wherein the indication for the cell to transition to the inactive state is included in a master information block (MIB), and wherein a bitfield in the MIB that indicates whether the cell is barred is ignored in response to the indication for the cell to transition to the inactive state.

10. The UE of claim 1, wherein the at least one processor is configured to cause the UE to send a request message for the cell to changes from an energy saving state to an active state, and wherein the request message indicates an expected quality of service (QoS), or a network slice, or a combination thereof.

11. The UE of claim 10, wherein the at least one processor is configured to cause the UE to receive a response message in response to the request message, wherein the response message rejects a request for the cell to change from the energy saving state to the active state, and wherein the response message further includes information of at least one neighbor cell being in the active state.

12. A method performed by a user equipment (UE), the method comprising:
camping on a cell;
receiving information indicating a change of a state of the cell; and
performing measurements for cell reselection based on the information indicating the change of the state of the cell, wherein the measurements for cell reselection comprise intra-frequency measurements, inter-frequency measurements, or inter-radio access technology (RAT) measurements, or a combination thereof.

13. The method of claim 12, wherein the state of the cell comprises a sleep state, wherein the sleep state indicates that no signals are transmitted or received during the sleep state, and wherein the measurements for cell reselection are performed regardless of:
a distance between the UE and a reference location of the cell;
whether a cell selection receiver level value is larger than a configured receiver level threshold values; or
whether a cell selection quality value is larger than a configured quality threshold values;
or a combination thereof.

14. A base station, comprising:
at least one memory; and
at least one processor coupled with the at least one memory and configured to cause the base station to:
transmit information indicating a change of a state of a cell, wherein the information indicating the change of the state of the cell comprises an indication for the cell to transition to a cell inactive state, and the cell transmits a discovery signal and channel only while in the cell inactive state.

15. The base station of claim 14, wherein the discovery signal and channel comprise a burst of synchronization signals and physical broadcast channel (PBCH) blocks and a burst of physical downlink channels carrying compact system information.

16. The base station of claim 15, wherein the compact system information:
comprises a configuration of the discovery signal and channel, cell selection related parameters, cell access related information, or a configuration for transmission of UE assistance information, or a combination thereof; and
does not include a serving cell configuration and system information (SI) scheduling information.

17. The base station of claim 15, wherein the indication for the cell to transition to the inactive state is included in a master information block (MIB).

18. The base station of claim 15, wherein the at least one processor is configured to cause the base station to receive a request message for the cell to changes from an energy saving state to an active state, and wherein the request message indicates an expected quality of service (QoS), or a network slice, or a combination thereof.

19. The base station of claim 18, wherein the at least one processor is configured to cause the base station to transmit a response message in response to the request message, wherein the response message rejects a request for the cell to change from the energy saving state to the active state, and wherein the response message further includes information of at least one neighbor cell being in the active state.

20. A method performed by a base station, the method comprising:
transmitting information indicating a change of a state of a cell, wherein the information indicating the change of the state of the cell comprises an indication for the cell to transition to a cell inactive state, and the cell transmits a discovery signal and channel only while in the cell inactive state.
